(19) United States
(12) Patent Application Publication
(10) Pub. No.: US 2022/0178151 A1
(43) Pub. Date: Jun. 9, 2022

(54) FOAM BOARD ARTICLES

(71) Applicant: DMX PLASTICS LIMITED, Brampton (CA)

(72) Inventor: Sundeepan SENNIK, Thornhill (CA)

(21) Appl. No.: 17/546,483

(22) Filed: Dec. 9, 2021

Related U.S. Application Data
(60) Provisional application No. 63/122,997, filed on Dec. 9, 2020.

(51) Int. Cl. E04F 15/18; B32B 3/28; B32B 29/00

(52) U.S. Cl. CPC E04F 15/185; B32B 3/28; B32B 29/007; B32B 2419/00; B32B 2266/0214; B32B 2250/02; B32B 2266/08

(57) ABSTRACT

A foam board article for installation against a base surface comprises a rigid foam layer including (a) a panel having an underside surface and a topside surface opposite the underside surface; and (b) a plurality of underside protrusions projecting from the underside surface for supporting the panel in spaced apart relation from the base surface to provide an air gap therebetween.

### CROSS-REFERENCE TO RELATED APPLICATIONS

This application claims the benefit of priority to U.S. Pat. Appn. Ser. No. 63/122,997, entitled “Foam Board Articles”, filed Dec. 9, 2020, and which is incorporated herein by reference.

### FIELD

The specification relates generally to foam board articles, and more specifically to foam board articles having rigid foam layers.

### BACKGROUND

U.S. Pat. No. 9,869,100 (Sennik) discloses an underlayment for a floor. The underlayment includes a dimpled substrate having a generally planar top side, an opposed bottom side, and a plurality of dimples formed therein. Each dimple is bounded by a dimple wall, and includes a dimple opening along the top side. A smoothing layer is bonded to the top side of the dimpled substrate and overlays and occludes the dimple openings.

U.S. Pat. No. 7,748,181 (Guinn) discloses a building envelope system for providing a continuous air, water, vapor and thermal barrier about a building structure. The building envelope system includes framing structurally connected to the building structure and at least one barrier panel attached to an outer face of the framing and providing an air, water, vapor and thermal barrier about the building structure. The at least one barrier panel includes a structural foam core and inner and outer facing sheets provided about the structural foam core. The at least one barrier panel provides structural support for an exterior facade system. The exterior facade system is attachable to the outer facing sheet of the at least one barrier panel such that the air, water, vapor and thermal barrier defined by the at least one barrier panel is maintained.

### SUMMARY

The following summary is intended to introduce the reader to various aspects of the applicant's teaching, but not to define any invention.

According to some aspects, a foam board article for installation against a base surface comprises a rigid foam layer including (a) a panel having an underside surface and a topside surface opposite the underside surface; and (b) a plurality of underside protrusions projecting from the underside surface for supporting the panel in spaced apart relation from the base surface to provide an air gap therebetween.

In some examples, the foam layer further includes a plurality of topside protrusions projecting from the topside surface of the panel for spacing the panel from an overlay surface positionable over the foam layer. The topside protrusions are interspersed between the underside protrusions.

In some examples, each protrusion has an endwall spaced apart from the panel, a sidewall extending from the panel to the endwall, and an interior bounded by the endwall and the sidewall, the interior open to a side of the panel opposite the protrusion.

In some examples, the protrusions comprise a plurality of dimples. In some examples, each dimple has a generally frustoconical shape.

In some examples, the protrusions comprise a plurality of ridges extending parallel with each other between opposed edges of the board.

In some examples, the foam board article further comprises a decoupling layer coupled to the rigid foam layer. In some examples, the decoupling layer is on an underside of the rigid foam layer. In some examples, the decoupling layer is bonded to the rigid foam layer. In some examples, the decoupling layer is bonded to the underside protrusions and is spaced apart from the panel. In some examples, the decoupling layer comprises a fabric sheet.

In some examples, the foam board article further comprises an integrated overlay surface on a topside of and coupled to the rigid foam layer. In some examples, the overlay surface is bonded to the rigid foam layer. In some examples, the overlay surface is bonded to the topside surface of the panel. In some examples, the overlay surface comprises a paper layer.

In some examples, the rigid foam layer is of integral, unitary, one-piece construction.

In some examples, the rigid foam layer has a generally constant thickness. In some examples, the thickness is between 4 mm and 10 mm.

In some examples, the rigid foam layer is formed of a closed-cell foam. In some examples, the rigid foam layer is formed from one of polypropylene (PP), polyvinyl chloride (PVC), polyethylene (PE), styrene, and polyethylene terephthalate (PET). In some examples, the foam layer is thermoformed.

In some examples, the foam board article is used as a subfloor and is installed between the base surface and an overlay surface. In some examples, the base surface comprises one of a concrete surface and a frame surface. In some examples, the overlay surface comprises a finished flooring article.

In some examples, the foam board article is used as a decoupling board and is installed between the base surface and an overlay surface. In some examples, the base surface comprises one of a concrete surface, a frame surface, and a subfloor surface. In some examples, the overlay surface comprises tiles. In some examples, the foam board article has a decoupling layer between the rigid foam layer and the base surface. In some examples the decoupling layer comprises a fabric sheet.

In some examples, the foam board article is used as an interior wall portion and is installed against framing. In some examples, the foam board article has an integrated paper layer opposite the framing for providing a generally flat wall surface.

### BRIEF DESCRIPTION OF THE DRAWINGS

The drawings included herewith are for illustrating various examples of articles, systems, and processes of the present specification and are not intended to limit the scope of what is taught in any way. In the drawings:

FIG. 1 is schematic plan view of an example foam board article;

FIG. 1A is an enlarged view of a portion of FIG. 1;

FIG. 2 is a cross-sectional view of a portion of the foam board article of FIG. 1, taken along line 2-2 in FIG. 1A;

FIG. 3 is a cross-sectional view like that of FIG. 2, but showing the foam board article between base and overlay surfaces;

FIG. 4 is an enlarged view of a portion of another example foam board article;

FIG. 5 is a cross-sectional view of a portion of the foam board article of FIG. 4, taken along line 5-5 in FIG. 4;

FIG. 6 is a cross-sectional view of a portion of another example foam board article shown being used as subflooring;

FIG. 7 is a cross-sectional view of a portion of another example foam board article shown being used as a decoupling board; and

FIG. 8 is a cross-sectional view of a portion of another example foam board article shown being used as an interior wall portion.

### DETAILED DESCRIPTION

Various articles, systems, or processes will be described below to provide an example of an embodiment of each claimed invention. No embodiment described below limits any claimed invention and any claimed invention may cover articles, processes, or systems that differ from those described below. The claimed inventions are not limited to articles, systems, or processes having all of the features of any one article, system, or process described below or to features common to multiple or all of the articles, systems, or processes described below. It is possible that an article, system, or process described below is not an embodiment of any claimed invention. Any invention disclosed in an article, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

The present disclosure is directed to aspects of foam board articles having rigid foam layers, and which may serve as, for example, underlayment, subflooring, decoupling, and/or wall boards, and may facilitate, for example, insulation, decoupling, and/or moisture evaporation and/or drainage.

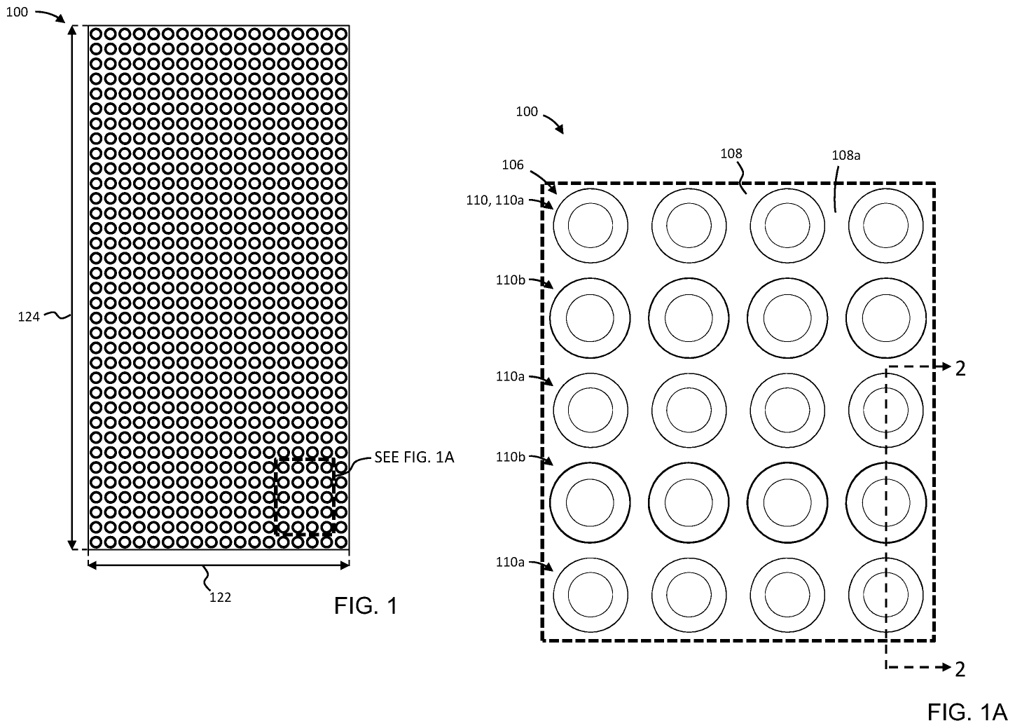

Referring to FIGS. 1 and 1A, an example foam board article 100 is illustrated. Referring to FIG. 3, in the example illustrated, the foam board article 100 is for installation against a base surface 102. In the example illustrated, the foam board article 100 is shown installed between the base surface 102 and an optional overlay surface 104. The base surface 102 can include, for example, a concrete floor and/or wall, framing (e.g. floor and/or wall framing), and/or a subfloor. The overlay surface 104 can include, for example, a finished flooring and/or wall product.

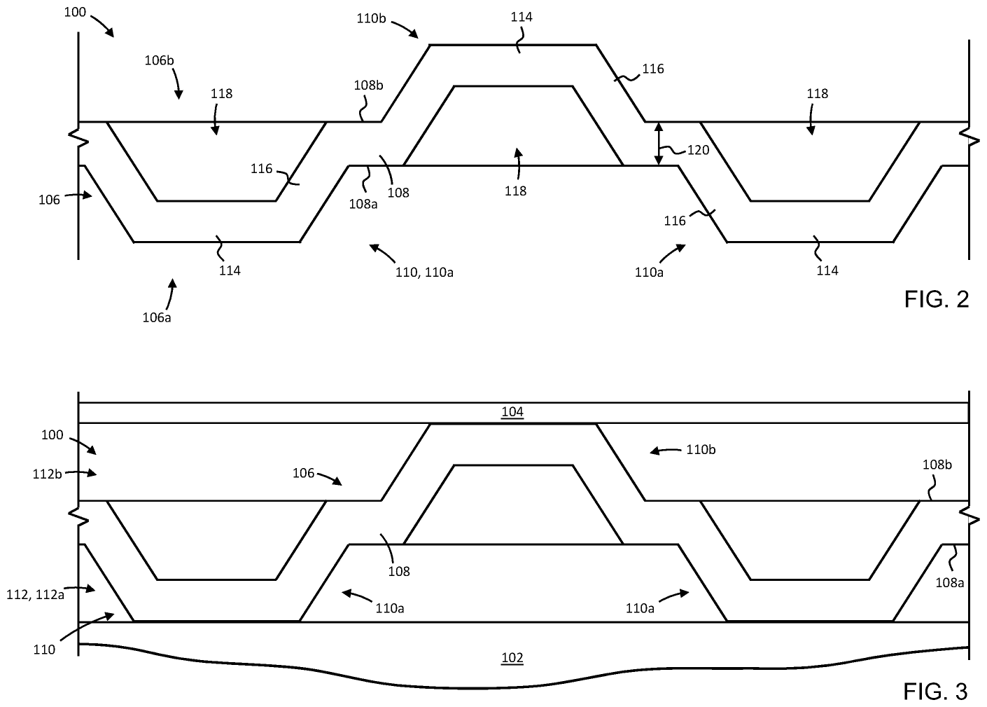

Referring to FIG. 2, in the example illustrated, the foam board article 100 comprises a rigid foam layer 106 having an underside 106a and a topside 106b opposite the underside 106a. In the example illustrated, the rigid foam layer 106 includes a panel 108 having a generally planar underside surface 108a that is coplanar with at least a portion of the underside 106a of the foam layer 106, and a generally planar topside surface 108b spaced apart from the underside surface 108a and that is coplanar with at least a portion of the topside 106b of the rigid foam layer 106. In the example illustrated, the rigid foam layer 106 includes a plurality of protrusions 110 projecting from the panel 108 (see also FIG. 1A). Referring to FIG. 3, the protrusions can help provide an air gap 112 between the base surface 102 and the overlay surface 104, which can facilitate moisture evaporation and/or drainage and help inhibit mold growth in some examples. The protrusions 110 may also help increase rigidity of the foam layer 106 and help reduce deflection (e.g. bowing) of the foam board article 100 and/or portions thereof before and/or after installation.

In the example illustrated, the protrusions 110 comprise a plurality of underside protrusions 110a projecting from the underside surface 108a of the panel 108 for supporting the panel 108 in spaced apart relation from the base surface 102. In the example illustrated, the underside protrusions 110a provide an underside air gap 112a between the panel 108 and the base surface 102. In the example illustrated, the protrusions 110 further comprise a plurality of topside protrusions 110b projecting from the topside surface 108b of the panel 108. In the example illustrated, the topside protrusions 110b are interspersed between the underside protrusions 110a. In the example illustrated, the topside protrusions 110b provide a topside air gap 112b between the panel and the overlay surface 104, which can further facilitate moisture evaporation and/or drainage and help reduce surface area contact between the foam board article 100 and the overlay surface 104.

Referring to FIG. 2, in the example illustrated, each protrusion 110 has an endwall 114 spaced apart from the panel 108, a sidewall 116 extending from the panel 108 to the endwall 114, and an interior 118 bounded by the endwall 114 and the sidewall 116. The interior 118 of each protrusion 110 is open to a side of the panel 108 opposite the protrusion 110. In the example illustrated, the interior 118 of each underside protrusion 110a is open to the topside surface 108b of the panel 108, and the interior 118 of each topside protrusion 110b is open to the underside surface 108a of the panel 108. In the example illustrated, the protrusions 110 comprise a plurality of dimples. Each dimple has a generally frustoconical shape in the example illustrated. In the example illustrated, the dimples are spaced apart from each other, and allow for airflow therebetween.

In the example illustrated, the rigid foam layer 106 is of integral, unitary, one-piece construction. In the example illustrated, the rigid foam layer has a generally constant thickness 120 extending in cross-section between opposed faces of the various wall segments (e.g. protrusion endwall, sidewall, panel) of the rigid foam layer 106. The thickness 120 can be between, for example, 4 mm and 10 mm or larger.

The rigid foam layer 106 can be formed from a polymeric material. The rigid foam layer 106 can be formed from one of polypropylene (PP), polyvinyl chloride (PVC), polyethylene (PE), styrene, and polyethylene terephthalate (PET). In some examples, the rigid foam layer 106 is formed of a closed-cell foam. The closed-cell foam can contain a gas such as, for example, nitrogen and/or carbon dioxide. In some examples, the rigid foam layer 106 can be thermoformed. In some examples, the rigid foam layer 106 can include one or more of calcium carbonate, mica, glass, and fiberglass. In some examples, the rigid foam layer comprises a fire retardant. In some examples, the rigid foam layer is water resistant.

Referring to FIG. 1, the foam board article 100 (including the rigid foam layer 106) is packaged for shipment and sale as a board having a width 122 and a length 124. The width 122 and length 124 can conform to standard sizes in the construction industry, such as a “4×8” sheet having a width 122 of 4 feet (1.2 m) and a length 124 of 8 feet (2.4 m). Referring to FIG. 3, installation of the foam board article 100 includes positioning the underside protrusions 110a against the base surface 102, with the panel 108 spaced apart from the base surface 102 to provide the air gap 112a (underside air gap 112a) therebetween. Optionally, suitable fasteners (e.g. nails and/or screws) can be driven through the rigid foam layer 106 and into the base surface 102 to secure the foam board article 100 into position. In some examples, another layer can be positioned between the underside protrusions 110a and the base surface 102.

Optionally, the foam board article 100 is cut into pieces of desired size. Seams between adjacent board articles 100 (or pieces thereof) can be sealed when joining adjacent boards or pieces thereof. In some examples, a suitable adhesive tape can be used to join the boards/pieces together and/or provide a seal therebetween.

After the foam board article 100 is in position, the overlay surface 104 is placed over the foam board article 100. In the example illustrated, the overlay surface 104 is placed against and supported by the topside protrusions 110b and is spaced apart from the panel 108 to provide the air gap 112b (topside air gap 112b). In some examples, another layer can be positioned between the topside protrusions 110b and the overlay surface 104 (and/or between the topside surface 108b of the panel 108 and the overlay surface 104).

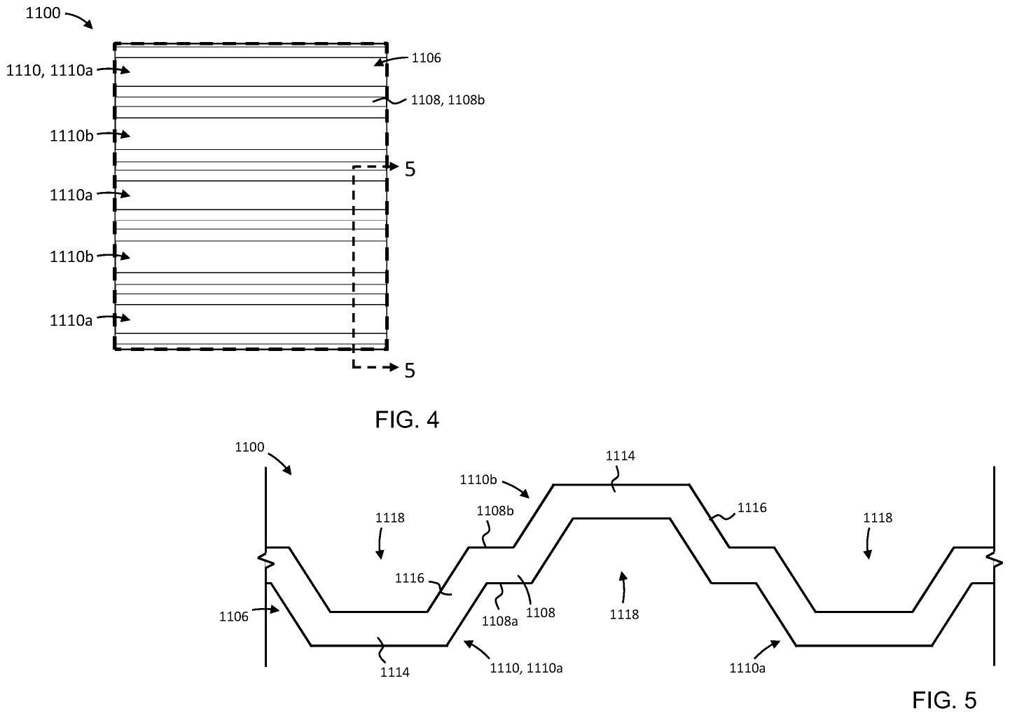

Referring to FIGS. 4 and 5, portions of another example foam board article 1100 are illustrated. The foam board article 1100 has similarities to the foam board article 100, and like features are identified using like reference characters, incremented by 1000.

In the example illustrated, the foam board article 1100 comprises a rigid foam layer 1106 including a panel 1108 having an underside surface 1108a and a topside surface 1108b opposite the underside surface 1108a. In the example illustrated, the rigid foam layer 1106 comprises protrusions 1110, including a plurality of underside protrusions 1110a projecting from the underside surface 1108a of the panel 1108 and a plurality of topside protrusions 1110b projecting from the topside surface 1108b of the panel 1108. The topside protrusions 1110b are interspersed between the underside protrusions 1110a. Each protrusion 1110 has an endwall 1114 spaced apart from the panel 1108, a sidewall 1116 extending from the panel 1108 to the endwall 1114, and an interior 1118 bounded by the endwall 1114 and the sidewall 1116. The interior 1118 of each protrusion 1110 is open to a side of the panel 1108 opposite the protrusion 1110. In the example illustrated, the protrusions 1110 comprise a plurality of ridges extending parallel with each other between opposed edges of the board, and the interiors 1118 define corresponding channels extending parallel with each other between opposed edges of the board.

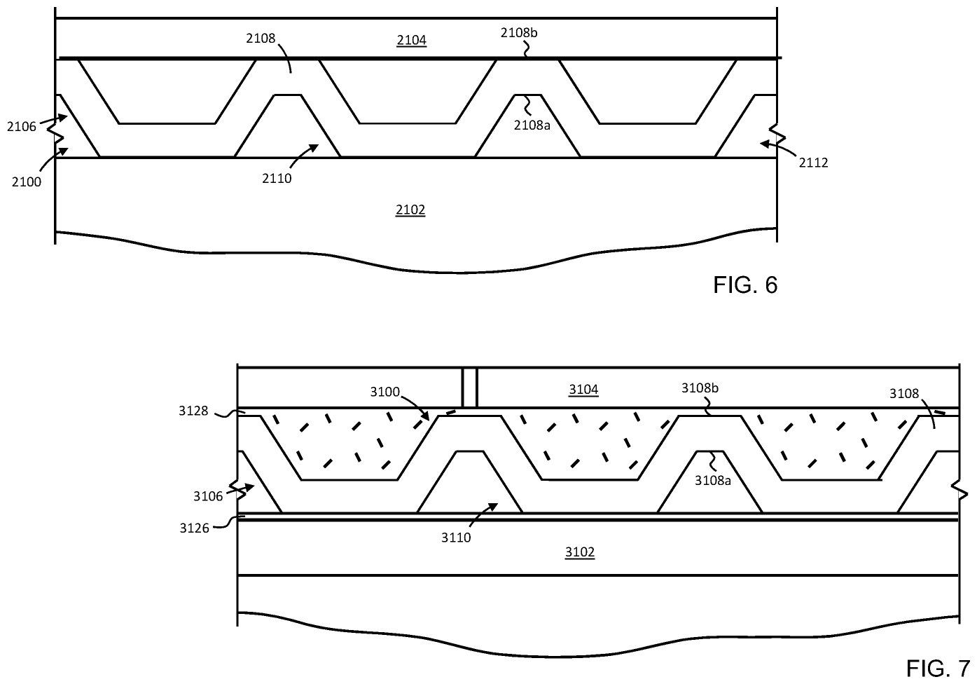

Referring to FIG. 6, portions of another example foam board article 2100 are illustrated. The foam board article 2100 has similarities to the foam board article 100, and like features are identified using like reference characters, incremented by 2000.

In the example illustrated, the foam board article 2100 serves as a subfloor, and is shown installed between a base surface 2102 (e.g. a concrete and/or framing surface) and an overlay surface 2104 (e.g. a finished flooring product such as, for example, hardwood or laminate flooring). In some examples, use of the foam board article 2100 as a subfloor can provide a solid feel for end users, similar to that of more traditional subfloor materials such as oriented strand boards (OSB) and/or plywood boards, while facilitating moisture evaporation and/or drainage and providing resistance to moisture damage and mold.

In the example illustrated, the foam board article 2100 comprises a rigid foam layer 2106 that can be fastened (e.g. through nails and/or screws) into the base surface 2102. The rigid foam layer 2106 includes a panel 2108 having a generally planar underside surface 2108a and a generally planar topside surface 2108b opposite the underside surface 2108a. In the example illustrated, the rigid foam layer 2106 comprises protrusions 2110 (in the form of dimples, in the example illustrated) projecting from the underside surface 2108a of the panel 2108. The protrusions 2110 can help provide increased structural rigidity and reduced vertical deflection for the foam board article 2100, and can provide an air gap 2112 between the panel 2108 and the base surface 2102 to facilitate moisture evaporation and/or drainage. In the example illustrated, the foam board article 2100 is free of topside protrusions, and the overlay surface 2104 is positioned against the topside surface 2108b of the panel 2108.

Referring to FIG. 7, portions of another example foam board article 3100 are illustrated. The foam board article 3100 has similarities to the foam board article 2100, and like features are identified using like reference characters, incremented by 1000.

In the example illustrated, the foam board article 3100 serves as a decoupling board, and is shown installed between a base surface 3102 (e.g. concrete, framing, and/or subflooring) and an overlay surface 3104 (e.g. a finished wall or floor cladding product such as, for example, ceramic tile). In some examples, use of the foam board article 3100 as a decoupling board may help to prevent moisture damage to the base surface, and may help to prevent damage to the cladding product including loosening or cracking of ceramic tiles.

In the example illustrated, the foam board article 3100 comprises a rigid foam layer 3106 including a panel 3108 having an underside surface 3108a and a topside surface 3108b opposite the underside surface 3108a. In the example illustrated, the topside surface 3108b is covered in a bonding layer 3128 (e.g. thinset mortar) to bond the overlay surface 3104 (in the form of tiles, in the example illustrated) to the foam board article 3100. In the example illustrated, the rigid foam layer 3106 comprises protrusions 3110 projecting from the underside surface 3108a of the panel 3108 and supporting the panel 3108 in spaced apart relation from the base surface 3102.

In the example illustrated, the foam board article 3100 includes a decoupling layer 3126 coupled to the rigid foam layer 3106. The decoupling layer 3126 can comprise, for example, a fabric sheet. In the example illustrated, the decoupling layer 3126 is on the underside of the rigid foam layer 3106. The decoupling layer 3126 can be bonded (e.g. fuse bonded and/or glued) to the rigid foam layer 3106, and in the example illustrated, the decoupling layer 3126 is bonded to the protrusions 3110 and spaced apart from the underside surface 3108a of the panel 3108. The decoupling layer 3126 can disengage when there is movement in the flooring to, for example, protect the overlay surface (in the form of tiles in the example illustrated) from cracking.

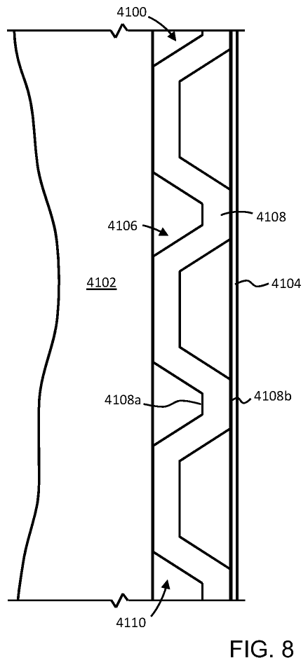

Referring to FIG. 8, portions of another example foam board article 4100 are illustrated. The foam board article 4100 has similarities to the foam board article 2100, and like features are identified using like reference characters, incremented by 2000.

In the example illustrated, the foam board article 4100 serves as an interior wall portion (e.g. as a substitute for drywall panels) and is shown installed against a base surface 4102 (in the form of wall framing in the example illustrated). In the example illustrated, the foam board article 4100 comprises a rigid foam layer 4106 including a panel 4108 having an underside surface 4108a and a topside surface 4108b opposite the underside surface 4108a. In the example illustrated, the rigid foam layer 4106 comprises underside protrusions 4110 projecting from the underside surface 4108a of the panel 4108 to space the panel 4108 apart from the base surface 4102 and provide an air gap therebetween.

In the example illustrated, the foam board article 4100 includes an integrated overlay surface 4104 on a topside of and coupled to the rigid foam layer 4106. The overlay surface 4104 can comprise, for example, a paper layer. This can allow the foam board article 4100 to resemble drywall when installed, and be painted and/or patched. In the example illustrated, the overlay surface 4104 is bonded to the rigid foam layer 4106. In the example illustrated, the overlay surface 4104 is positioned against and bonded to the topside surface 4108b of the panel 4108 and is spaced apart from interior surfaces of the protrusions 5110 to provide a generally flat interior wall surface.

1. A foam board article for installation against a base surface, comprising: a rigid foam layer including (a) a panel having an underside surface and a topside surface opposite the underside surface; and (b) a plurality of underside protrusions projecting from the underside surface for supporting the panel in spaced apart relation from the base surface to provide an air gap therebetween.

2. The foam board article of claim 1, wherein the foam layer further includes a plurality of topside protrusions projecting from the topside surface of the panel for spacing the panel from an overlay surface positionable over the foam layer, the topside protrusions interspersed between the underside protrusions.

3. The foam board article of claim 1, wherein each protrusion has an endwall spaced apart from the panel, a sidewall extending from the panel to the endwall, and an interior bounded by the endwall and the sidewall, the interior open to a side of the panel opposite the protrusion.

4. The foam board article of claim 1, wherein the protrusions comprise a plurality of dimples.

5. The foam board article of claim 1, wherein the protrusions comprise a plurality of ridges extending parallel with each other between opposed edges of the board.

6. The foam board article of claim 1, further comprising a decoupling layer coupled to the rigid foam layer.

7. The foam board article of 6, wherein the decoupling layer is on an underside of the rigid foam layer.

8. The foam board article of claim 7, wherein the decoupling layer is bonded to the underside protrusions and spaced apart from the panel.

9. The foam board article of claim 1, further comprising an integrated overlay surface on a topside of and coupled to the rigid foam layer.

10. The foam board article of claim 9, wherein the overlay surface is bonded to the topside surface of the panel.

11. The foam board article of claim 9, wherein the overlay surface comprises a paper layer.

12. The foam board article of claim 1, wherein the rigid foam layer is of integral, unitary, one-piece construction.

13. The foam board article of claim 1, wherein the rigid foam layer has a generally constant thickness, and the thickness is between 4 mm and 10 mm.

14. The foam board article of claim 1, wherein the rigid foam layer is formed of a closed-cell foam.

15. The foam board article of claim 1, wherein the rigid foam layer is formed from one of polypropylene (PP), polyvinyl chloride (PVC), polyethylene (PE), styrene, and polyethylene terephthalate (PET).

16. The foam board article of claim 1, wherein the foam layer is thermoformed.
